(19) United States
(12) Patent Application Publication
(10) Pub. No.: US 2012/0069291 A1
(43) Pub. Date: Mar. 22, 2012

(54) Method and apparatus for viewing objects in bright light

(76) Inventor: David Singelyn, Lake Elsinore, CA (US)

(21) Appl. No.: 12/924,075

(22) Filed: Sep. 21, 2010

(51) Int. Cl. G02C 9/00

(52) U.S. Cl. 351/47; 351/178

(57) ABSTRACT

A viewing apparatus configured to aid an individual viewing objects in bright light and a method for selling a viewing apparatus for viewing objects. The apparatus according to the present invention includes a light diminishing surface including at least one aperture and being configured to prevent extraneous light around an object from reaching the eye(s) of the individual, wherein the at least one aperture being configured to allow at least some of the light reflecting and/or emanating from the viewed object to reach the individual's eye(s) and the at least one aperture further configured to correspond to the dimensions of the viewed object.

### BACKGROUND OF THE INVENTION

The present invention generally relates to a method and an apparatus for viewing objects in brightly lit environments such as outdoors, and more particularly, to a method and an apparatus having one or more apertures, which are configured to allow at least some of the light reflecting from and/or emanating from a viewed object to reach the viewer's eyes and are further configured to correspond to the dimensions of the viewed object.

Individuals are increasingly using laptop/notebook computers, pda phones (e.g., Research in Motion's Blackberry, Apple's iPhone and Google's Android) and e-viewers (such as Amazon's Kindle and Apple's iPad) to view a large variety of digital content at the location of their choosing, such as outdoors. This trend is expected to continue with the advent of an increasing number of portable devices, such as digital paper (e.g., Livescribe's dot paper) and portable satellite television sets (e.g., DIRECTV's Sat-Go). While users of these devices, and their home-based counterparts (e.g., televisions, desktop computers, etc.) would like in many instances to use these devices in brightly lit rooms or outdoors (e.g., to enjoy the sunshine and fresh air), the bright ambient light present in these environments severely limits visibility of the device's screen and moreover can lead to eye strain and fatigue. These obstacles often force the user to retreat to a darker environment such as indoors to use their device.

Prior art headwear (e.g., baseball caps) invariably leave a significant amount of open space around the edges of a viewed object which allows large amounts of extraneous ambient light to reach the eye of the observer, diminishing the brightness and image quality of the object the viewer desires to see. In the case of electronic screens, colors and images become washed out and text becomes difficult or impossible to read(a similar loss of visual detail also occurs when viewing 3 dimensional objects) when the glare from ambient light or reflections from other objects and surfaces appears brighter than the light reflecting and/or emanating from the object of interest. Prior attempted solutions, such as those disclosed in U.S. Pat. No. 6,386,701 B1 entitled “Eyewear for Relief of Computer Vision Syndrome” (Issued: May 14 2002) fail to solve these problems because they do not tailor a light diminishing surface to correspond closely enough to the viewed object and they leave unacceptably large areas open to the intrusion of unwanted extraneous light.

The human eye utilizes an array of rods and cones to transmit visual data to the brain, and these rods and cones need a certain strength of incoming light in order to work properly. Moreover, the pupil of the human eye controls the amount of light reaching the retina by growing smaller in bright light and larger in dim light. If a person's pupils are contracted in an environment having bright ambient light (e.g., outdoors), then the intensity of the light coming from the dimly lit objects is relatively small in terms of making an impression on the eye's rods and cones compared to the ambient light. This results in the light reflecting and/or emanating from the dimly lit objects appearing to have a relatively small level of brightness, color and clarity to the observer due to the ambient light. For example, it is very difficult to determine if a light bulb is lit when observed in full sunlight, however at night there is no trouble at all seeing that the bulb is on. Similarly, while television and laptop screens are plainly visible indoors, they are practically impossible to use outdoors, as was recognized in US Patent Application 20040046927 entitled “Polarized and non-polarized bifocal spectacles” (Published: Mar. 11, 2004), which states: “cathode ray tubes, light emitting diode displays, and florescent screens are often impossible to read in bright sunlight.” So, it can be seen that a solution to the problem of viewing such objects in bright light is needed.

### SUMMARY OF THE INVENTION

In the present invention, a viewing apparatus configured to aid an individual viewing an object in bright ambient light, includes: a light diminishing surface comprising at least one aperture and being configured to prevent extraneous light around an object from reaching the eyes of the individual, wherein the at least one aperture being configured to allow at least some of the light reflecting and/or emanating from the viewed object to reach the individual's eyes and the at least one aperture is further configured to correspond to the dimensions of the viewed object.

In another embodiment of the present invention, a wearable viewing apparatus, includes: an adjustable means for preventing extraneous light around an object being viewed from reaching the eyes of viewer comprising at least one aperture, wherein the adjustable means is configured to be adjusted by the wearer to correspond to the size of the object being viewed to aid in preventing extraneous light around an object from reaching the eyes of viewer.

In still another embodiment of the present invention, a method for selling a viewing apparatus customized to an individual wherein the viewing apparatus facilitates viewing in brightly lit areas, includes: displaying different sized and shaped viewing objects to an individual; and determining based on a chosen viewed object a viewing apparatus having at least one aperture formed therein that allows the individual to view the chosen viewed object in brightly lit conditions while keeping extraneous light away from the individual's eyes.

These and other features, aspects and advantages of the present invention will become better understood with reference to the following drawings, description and claims.

### BRIEF DESCRIPTION OF THE DRAWINGS

FIG. 1 is a perspective view of a viewing apparatus according to an embodiment of the present invention;

FIG. 2 is a perspective view of a viewing apparatus according to an embodiment of the present invention;

FIG. 3 is a flow chart of a method for selling a viewing apparatus customized to an individual wherein the viewing apparatus facilitates viewing in brightly lit areas according to an embodiment of the present invention; and

FIG. 4 is a perspective view of a viewing apparatus according to an embodiment of the present invention.

### DETAILED DESCRIPTION OF THE INVENTION

A detailed description of one or more embodiments of the invention is provided below along with accompanying figures that illustrate the principles of the invention. The invention is described in connection with such embodiments, but the invention is not limited to any embodiment. The scope of the invention encompasses numerous alternatives, modifications, and equivalents. Numerous specific details are set forth in the following description in order to provide a thorough understanding of the invention. These details are provided for the purpose of example, and the invention may be practiced according to the claims without some of all of these specific details. For the purpose of clarity, technical material that is known in the technical fields related to the invention has not been described in detail so that the invention is not unnecessarily obscured.

Before the Figures are described, instructions for interpreting the words and phrases of this patent document will be set forth. Since many jurisdictions, such as the United States, allow a patentee to act as his/her own lexicographer, the following section provides rules for interpreting words, terms and phrases of this particular patent document.

### Interpretive Rules:

Rule 1: There is a “Specially Defined Terms” section set forth below. Only words, terms or phrases that are explicitly defined in the Specially Defined Terms are to be considered to have a special definition, and the explicit definition provided herein is to serve as the definition for these terms. Accordingly, the patent specification and extrinsic evidence shall not be used to help define these terms; the explicitly provided definitions shall control.

Rule 2: If a word, term or phrase is not specially defined, then its definition shall be determined in the first instance by resort to dictionaries and technical lexicons in existence at the time this patent document is filed. (See definition of “dictionaries and technical lexicons” below in the Specifically Defined Terms section.). It is acknowledged that dictionaries and technical lexicons often provide alternative definitions. Also, definitions provided in different dictionaries and different lexicons often differ and are not always entirely consistent. In that case, it must be decided which definition is in best accordance with this document. Rules 3 and 4, set forth below, provide some guidelines for choosing between alternative definitions for a word, term or phrase.

Rule 3:The role of the specification (other than the Specially Defined Terms section) as an interpretive or definitional aid shall be limited to helping choose between alternative definitions that meet the requirements of Rule 2 (above).

Rule 4: The role of extrinsic evidence (e.g., expert witnesses) as an interpretive or definitional aid shall be limited to helping choose between alternative definitions that meet the requirements of Rule 2 (above).

### Specially Defined Terms

the present invention: means at least some embodiments of the present invention; references to various feature(s) of the “present invention” throughout this document do not mean that all claimed embodiments or methods include the referenced feature(s).

dictionaries and/or technical lexicons: any document whose primary purpose is the definition of words, terms and/or phrases; on the other hand, documents that merely discuss, explain or provide examples of devices or methods, without providing definitions of specific words, phrases or terms, are not to be considered as dictionaries and/or technical lexicons.

extraneous light around an object: any light that appears next to the viewed object which is not light reflecting off of and/or emanating from the viewed object(s).

headwear: any form of apparatus worn on or about the head, such as but not limited to a monocle, a pair of glasses, a set of goggles, a hat, a burka, and the like.

light diminishing surface: a surface that prevents at least some extraneous light around an object from passing through it to enter the individual's eye.

aperture: area that allows light reflecting off of and/or emanating from the viewed object(s) to enter the individuals eye; this light is of a higher visible intensity than any light, if it exists, which passes through the light diminishing surface. viewed object: a single object or a plurality of objects; object(s).

lens: material, possessing any degree of transparency, which is positioned in proximity of an individual's eye(s).

To the extent that the definitions provided above are consistent with ordinary, plain and accustomed meanings, the above definitions shall be considered supplemental in nature. To the extent that the definitions provided above are inconsistent with ordinary, plain and accustomed meanings, the above definitions shall control. If the definitions provided above are broader than the ordinary, plain and accustomed meanings in some aspect, then the above definitions will control at least in relation to their broader aspects.

To the extent that a patentee may act as its own lexicographer under applicable law, it is hereby further directed that all words appearing in the claims section, except for the above-defined words, shall take their ordinary, plain and accustomed meanings (as generally evidenced, by dictionaries and technical lexicons), and shall not be considered to be specially defined in this specification. Notwithstanding this limitation on the inference of “special definitions,” the specification may be used to evidence the appropriate ordinary, plain and accustomed meanings (as generally evidenced by dictionaries and/or technical lexicons), in a situation where a word or terms used in the claims has more than one alternative ordinary, plain and accustomed meaning and the specification is helpful in choosing between the alternatives.

Broadly, the present invention generally provides a viewing apparatus for viewing in brightly lit environments (e.g., outdoors) to prevent extraneous light from around the viewed object from reaching the eyes of the viewer. In the case of electronic screens for example, manufacturers have tried to increase the brightness of their screens, but the overwhelming power of bright ambient light (e.g., sunlight) can make this futile. The use of mechanical canopies, such as those offered at laptopsunshade.com, limits the ease of use and portability of laptop computers, and are unsuitable for other types of electronic devices such as cell phones or iPads. Unlike the prior art, the present invention provides a convenient and portable viewing apparatus which can be tailored to the observed object or device that prevents excess extraneous light around an object from entering a user's eye(s) while viewing in brightly lit environments such as outdoors.

The invention(s) disclosed herein addresses the problem described in US Patent Application 20040046927, discussed above, by enhancing the visual clarity of any type of electronic screen viewed in bright light (e.g., sunlight) by utilizing a convenient and portable light diminishing surface designed to limit unwanted light from reaching the observer's eye(s), and at least one aperture configured to the dimensions of the viewed object which allows the desired light to pass through. The invention also enhances the clarity of other objects viewed in bright light conditions. Subtle visual details of flora and fauna for example become more clearly visible when ambient light is reduced and an aperture configured to the approximate dimensions of the viewed object is employed. Since users may desire to enhance the visual clarity of any number of differently sized and shaped objects viewed in brightly lit environments, variations of the aperture(s) can easily be made by manufacture or adjustment to closely match the edges of virtually any two or three dimensional object(s) the user desires to view.

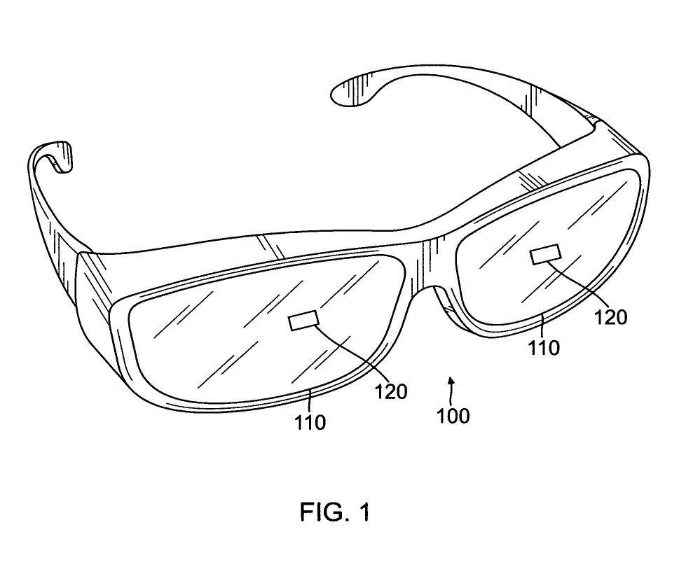

Referring now to the figures, FIG. 1 is a perspective view of a viewing apparatus according to the present invention. FIG. 1 includes a viewing apparatus 100 including a light diminishing surface 110 wherein the light diminishing surface includes apertures 120.

Viewing apparatus 100 can be a pair of glasses, a detachable attachment to a pair of glasses, a pair of goggles, a hat, a scarf, a headgear, a headband or any other similar object that includes a light diminishing surface that can be worn or held over or in front of a user's eye(s).

Light diminishing surface 110 can be made of materials such as plastic, glass, metal, a translucent material, photoelectric, photochromatic, and/or a polymer or the like. Light diminishing surface 110 can be a lens (for example, a prescription lens or sunglass lens), an attachable structure, a hinged structure, an overhanging structure, a projecting surface, a draping structure, an attachable sticker, a detachable sticker, a magnet or a piece of clothing. The possible materials and physical designs which could be used to create the light diminishing surface referred to herein is virtually endless. The term “light diminishing surface” does not necessarily imply a complete blocking of extraneous light. One version of a light diminishing surface for the present invention is a pair of tinted glasses or goggles, hereby referred to as sunglasses. Sunglasses by their nature admit some light through their lenses, and also might allow some oblique light to enter the eye from the top, bottom, sides, and nosepiece areas. Ideally this type of undesired lighting will be eliminated by frames and tinted sections that fit tightly to the head, although if this is not the case, it does not negate the usefulness of the invention. This oblique light, though undesired, is less destructive to the quality of the image of the viewed object than is the light coming into the eye(s) from the area immediately around the edges of the viewed object. This light is more directly in the focal plane of the eye(s), and therefore will have more of an impact on the pupil size, and hence, a more deleterious effect on the image quality of the viewed object. Ideally an aperture will be chosen or adjusted so as to perfectly match the edges of the viewed object. If eliminating all the light from around the edges of the viewed object is not possible, then a less than perfect match which closely approximates the dimensions of the viewed object and eliminates much of the surrounding light is still acceptable and will greatly enhance the view of the desired object.

The light diminishing surface can be completely opaque to eliminate all light not coming from the aperture, and one advantage of such a configuration is that the eye will have no appreciable extraneous light competing with the light from the desired object, thereby garnering maximum pupil dilation and image detail. The advantages of a semi-translucent “sunglasses” type of light diminishing surface is that while viewing their computer, book, or whatever object they may be viewing, users can still visually experience other things going on around them, which is often an important reason a person might have desired to use their device outside in the first place (e.g., to enjoy the experience of being at the beach or the park, etc.).

Apertures 120 can be open spaces (e.g, various sized and shaped holes), or made from detachable plugs with various sized and shaped openings, or the apertures may be made of translucent materials such as plastic, glass, a.

photochromatic material and/or a polymer material, photoelectric material, a lens, a magnifying device, a light filter, CCD or other type of light gathering or transmitting device, and may be configured to have an electronic or manually operated shutter (e.g., a camera-type shutter). Apertures 120 can be relatively small (e.g., less than one centimeter in diameter) to allow enough light in to view an object but small enough to prevent extraneous light from reaching the user's eyes. The placement of apertures 120 on the light diminishing surface 110 can be determined by an analysis of the geometry of an individual's facial geometry (e.g., by a user trying on the viewing apparatus and using lines of sight from the apertures to the outer perimeter of a viewed surface).

If an aperture is a hole, or a translucent substance, then the edges can be manufactured to be adjustable to reasonably match the edges of the viewed object. Since user(s) may desire to enhance the visual clarity of any number of differently sized and shaped objects viewed in brightly lit environments, variations of the apertures can be made by manufacture or adjustment to closely match the edges of virtually any two or three dimensional object the user desires to view. For example, the apertures can be pre-manufactured or adjustable to be rectangular in nature to match rectangular electronic screens such as cell phones, laptops, televisions, iPads, and e-readers, making the screens of these devices plainly visible in bright light such as outdoors. Print media such as newspapers, magazines, or books are also rectangular in nature and are likewise difficult to read in the glare of sunlight making them suitable candidates for similar pre-manufactured or adjustable rectangular apertures. In the case of three dimensional objects, differently sized and shaped objects will call for differently sized and shaped apertures, and many methods can be imagined for creating these differently shaped apertures, such as but not limited to manufacturing the light diminishing surface with holes sized for drop-in plugs which could have the shape of any object pre-cut into the plug, allowing a very close fit between its edges and the edges of the viewed object. Various mechanical means can also be employed to create adjustable apertures in size and shape to accommodate viewed surfaces and objects, such as but not limited to sliders, shutters, louvers and the like. Clear apertures could be manufactured into the headwear sized and shaped to the close approximation of the object(s) to be viewed, and users could select the most suitable headwear by choosing from various samples the one with aperture(s) best fitted to their personal eye configuration (i.e., ocular location) and optionally, using mock samples of the computer screen or other objects they may be viewing set at different, commonly-encountered distances. Other aperture iterations can be imagined, such as photoactive or electronically controlled tinting of the light diminishing surface to make a “clear” area (e.g., an aperture devoid of any light diminishing material) in the shape of the object or screen to be viewed. Such electronically created apertures could also be made by using imaging technology such as that which is used in modern cameras to automatically locate the face of the subject, and with such imaging technology electronically re-creating the image of the viewed object into an exactly matching aperture in or on what in this case would be a material made at least in part with a type of optically alterable material such as but not limited to electronically tinted or tintable glass or plastic. Many other methods of creating an aperture configured to the viewed object are possible, and the description of the above methods in no way excludes other methods of creating an aperture in a light diminishing surface but are simply included to illustrate the principles involved.

According to the present invention, a mechanism for moving the apertures 230 is configured to allow the position of at least one of the apertures to be adjusted. According to the present invention, the front light diminishing surface is configured to allow the position of at least one of the apertures to be adjusted to conform to the size or shape of the viewed object. This can be done using mechanical mechanisms (e.g., straight or shaped aperture edges that adjust laterally, vertically, diagonally or a combination thereof), a mechanical shutter, slider, louvers or the like, an electronic mechanism (e.g., photoelectric shading), an electromechanical mechanism (e.g., an electronically controlled shutter, sliders, louvers or the like), Velcro attachment, using one or more stickers, a magnet, an adjustable band or the like, or a moldable substance to create the aperture shape using a putty-like material to conform to the size and shape of viewed objects or variations thereof.

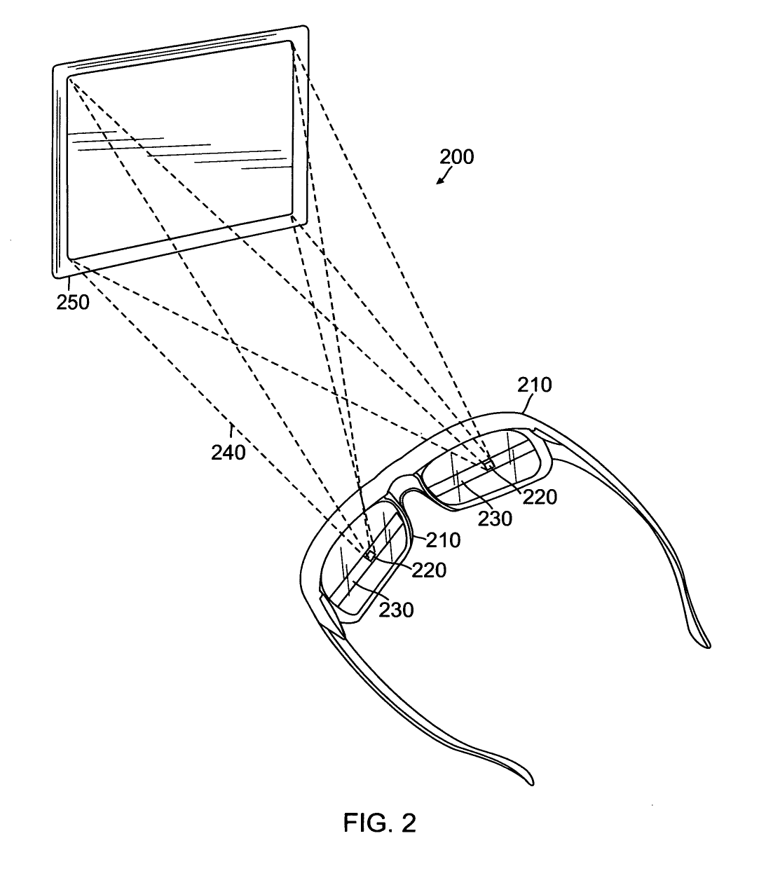

FIG. 2 is a perspective view of a viewing apparatus to the present invention. FIG. 2 includes a viewing apparatus 200 including a light diminishing surface 210 wherein the light diminishing surface includes apertures 220 and a mechanism for moving the apertures 230. Also shown are lines of sight 240 from the apertures 220 to a viewing surface 250.

Viewing apparatus 200 can be a pair of glasses, a detachable attachment to a pair of glasses, a pair of goggles, a hat, a scarf, a headgear, headband or any other similar object that includes a light diminishing surface that can be held or worn over or in front of a user's eyes.

Light diminishing surface 210 can be made of plastic, glass, metal, a translucent material, photoelectric, a photochromatic material and/or a polymer material. Light diminishing surface 210 can be a lens (for example, a prescription lens), an attachable structure, a hinged structure, an overhanging structure, a projecting surface, a draping structure, an attachable sticker, a detachable sticker, a magnet or a piece of clothing.

Apertures 220 can be fixed or adjustable open spaces (e.g., various sized and shaped holes), or made from detachable plugs with various sized and shaped openings, or the apertures may be made of translucent materials (e.g., plastic, glass, a photochromatic material and/or a polymer material), a photoelectric material, a lens, magnifying device, light filter, CCD or other type light gathering or transmitting device, an electronic or manually operated shutter (e.g., a camera-type shutter). Apertures 220 can be relatively small (e.g., less than one centimeter in diameter) to allow enough light in to view a surface of an object but small enough to prevent too much extraneous light from reaching the user's eye(s). The placement of apertures 220 on the light diminishing surface 110 can be determined by an analysis of the geometry of an individual's facial geometry (e.g., by a user trying on the viewing apparatus and using lines of sight 240 from the apertures 220 to the outer perimeter of a viewing surface 250).

According to the present invention, a mechanism for moving the apertures 230 is configured to allow the position of at least one of the apertures to be adjusted to conform to the shape of the viewed object. This can be done using mechanical mechanisms (e.g., straight or shaped aperture edges that can be adjusted laterally, vertically, diagonally or a combination thereof), a mechanical shutter, slider, louvers or the like, an electronic mechanism (e.g., photoelectric shading), an electromechanical mechanism (e.g., electronically controlled shutters, sliders, louvers or the like), Velcro attachment, using one or more stickers, a magnet, an adjustable band or the like, or a moldable substance to create the aperture shape using a putty-like material or variations thereof.

According to the present invention, the viewed object 250 can be a screen(s) (e.g., for a laptop computer, television, an e-viewer, iPhone or the like), a viewing material(s) (for example, a newspaper, a book, a magazine, natural objects (e.g., flora and fauna), manufactured part(s) (e.g., computer chips or the like), or any object(s) viewed in bright light whose general shape an aperture could be made to fit.

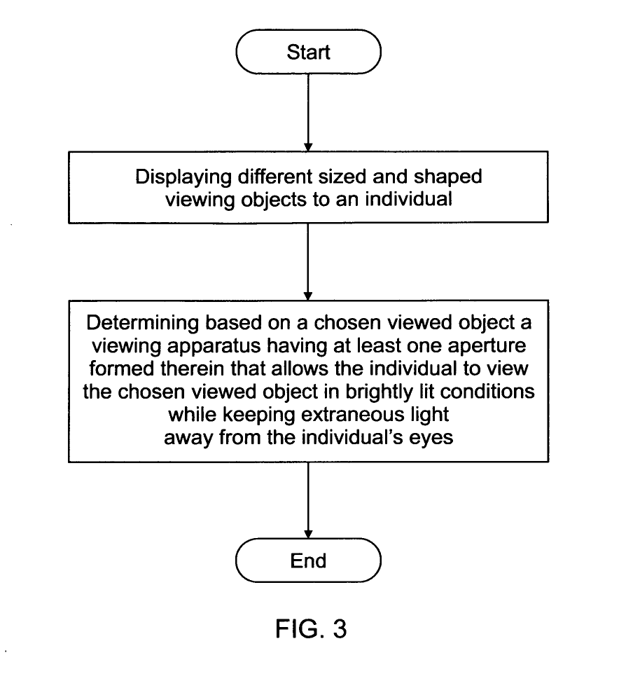

FIG. 3 shows a flow chart of method for selling a viewing apparatus customized to an individual wherein the viewing apparatus facilitates viewing in brightly lit areas according to an embodiment of the present invention. The method 300 starts 310 by displaying different sized and shaped viewing objects to an individual 320. Displaying can be by displaying different sized objects to show the size of their viewing surfaces, mock renditions of viewing surfaces (e.g., different sized rectangles representing different sized computer screens) or visual displays of objects (e.g., using an electronic terminal to display the sizes and shapes of various objects or viewing surfaces and/or specifying the dimensions of the viewing surfaces). Then a determination is made, based on a chosen viewing area, of a viewing apparatus having at least one aperture formed therein that allows the user to view the chosen object(s) brightly lit conditions while keeping extraneous light away from the user's eye(s) 330, and the method ends 340. The determination can be made by an individual (e.g., the person trying on the viewing apparatus or by a person selling the viewing apparatus such as a retail employee) and/or by a processor (e.g., by a CPU in a computer containing specialized instructions for carrying out this decision) as would be understood by one having ordinary skill in the art.

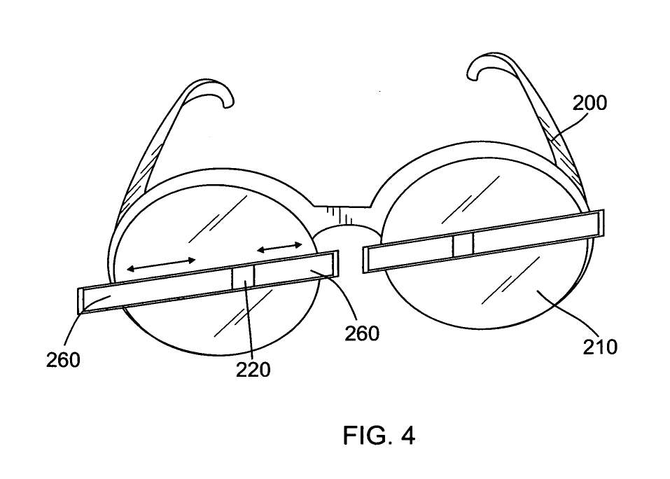

FIG. 4 is a perspective view of a viewing apparatus to the present invention. FIG. 4 includes a viewing apparatus 400 including a light diminishing surface 410 wherein the light diminishing surface includes apertures 420 and a mechanism for moving the apertures 430.

It should be understood, of course, that the foregoing relates to exemplary embodiments of the invention and that modifications may be made without departing from the spirit and scope of the invention as set forth in the following claims. Moreover, reference in the specification to “embodiment” means that a particular feature, structure, or characteristic described in connection with the embodiment is included in at least the present invention of the invention. The appearance of the word “embodiment” in various places in the specification are not necessarily all referring to the same embodiment, nor are separate or alternative embodiments mutually exclusive of other embodiments. Also, regarding the disclosed methods, in general, the order of the steps of the disclosed methods may be altered within the scope of the invention.

I claim:

1. A viewing apparatus configured to aid an individual viewing an object in bright ambient light, comprising:
a light diminishing surface comprising at least one aperture and being configured to prevent extraneous light around an object from reaching the eyes of the individual, wherein the at least one aperture being configured to allow at least some of the light reflecting and/or emanating from the viewed object to reach the individual's eyes and the at least one aperture is further configured to correspond to the dimensions of the viewed object.

2. The viewing apparatus of claim 1, wherein the light diminishing surface comprises a lens.

3. The viewing apparatus of claim 1, wherein the cross sectional area of the at least one aperture is less than one centimeter in diameter.

4. The viewing apparatus of claim 2, wherein the viewing apparatus comprises one of a pair of glasses and a pair of goggles.

5. The viewing apparatus of claim 4, wherein the light diminishing surface comprises a detachable sticker configured to be attached to a pair of glasses and/or a pair goggles.

6. The viewing apparatus of claim 2, wherein the viewing apparatus comprises one of a hat, a head band, a head gear, a scarf and an attachment.

7. The viewing apparatus of claim 1, wherein the location of the at least one aperture on the light diminishing surface is determined by an analysis of an individual's facial geometry.

8. The viewing apparatus of claim 1, wherein the light diminishing surface is further configured to allow the location of at the least one aperture on the light diminishing surface to be adjusted.

9. The viewing apparatus of claim 1, wherein the light diminishing surface comprises one of plastic and glass and wherein the at least one aperture is formed by locating at least one hole in the light diminishing surface.

10. The viewing apparatus of claim 1, wherein the light diminishing surface is further configured to allow the size of the at least one aperture to be adjusted.

11. The viewing apparatus of claim 1, wherein the light diminishing surface is further configured to allow the shape of the at least one aperture to be adjusted.

12. The viewing apparatus of claim 1, wherein the at least one aperture is no larger than is needed to allow the viewer to view the complete viewing surface of the object.

13. A wearable viewing apparatus, comprising:
an adjustable means for preventing extraneous light around an object being viewed from reaching the eyes of viewer comprising at least one aperture, wherein the adjustable means is configured to be adjusted by the wearer to correspond to the size of the object being viewed to aid in preventing extraneous light around an object from reaching the eyes of viewer.

14. The wearable viewing apparatus of claim 13, wherein the adjustable means for preventing extraneous light around an object from reaching the eyes of viewer comprises a lens.

15. The viewing apparatus of claim 13, where an adjustable means for preventing extraneous light around an object from reaching the eyes of viewer comprises a detachable sticker.

16. The viewing apparatus of claim 13, wherein the object being viewed comprises one of a computer and an electronic device, wherein the computer or electronic device utilizes a viewing screen.

17. A method for selling a viewing apparatus customized to an individual wherein the viewing apparatus facilitates viewing in brightly lit areas, comprising:
displaying different sized and shaped viewing objects to an individual; and
determining based on a chosen viewed object a viewing apparatus having at least one aperture formed therein that allows the individual to view the chosen viewed object in brightly lit conditions while keeping extraneous light away from the individual's eyes.

18. The method of claim 17, wherein the viewing apparatus comprises one of a pair of glasses and goggles; and the method further comprises determining an individual's facial geometry.

19. The method of claim 17, wherein the viewing apparatus further comprises one of a pair of glasses and a pair goggles; and the determining of an appropriate viewing apparatus further comprises providing a plurality of pairs of glasses and/or goggles for the individual to try on.

20. The method of claim 17, wherein the different sized viewing areas comprise one of actual screens, mock screens and electronic devices having screens.
